(19) United States
(12) Patent Application Publication
(10) Pub. No.: US 2024/0170777 A1
(43) Pub. Date: May 23, 2024

(54) POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Tsuyoshi EHARA, Toyota-shi (JP); Yozo UCHIDA, Toyota-shi (JP); Yuki SATO, Toyota-shi (JP); Syoichi TSUCHIYA, Toyota-shi (JP); Masataka ASAI, Toyota-shi (JP); Tsuyoshi ASANO, Toyota-shi (JP); Masahiro UCHIMURA, Toyota-shi (JP); Takashi TAKIMOTO, Kosai-shi (JP); Shigeru MATSUMOTO, Toyohashi-shi (JP); Yasuaki NAGANO, Kosai-shi (JP)

(21) Appl. No.: 18/493,806

(22) Filed: Oct. 25, 2023

(30) Foreign Application Priority Data
Nov. 21, 2022 (JP) 2022-185482

(51) Int. Cl. H01M 50/188; H01M 50/103; H01M 50/184; H01M 50/557

(52) U.S. Cl. CPC H01M 50/188; H01M 50/103; H01M 50/184; H01M 50/557

(57) ABSTRACT

A power storage device includes a case member, a terminal member inserted in an insertion hole of the case member, and a resin member joined to the case member and the terminal member. The resin member includes, on a resin outer surface exposed on an outer side of the case member, at least any one of a recess and a projection portion increasing a creepage distance from a terminal outer surface, which is exposed on the outer side of the case member, of the terminal member to a case outer surface exposed on the outer side of the case member.

### CROSS-REFERENCE TO RELATED APPLICATIONS

This application is based upon and claims the benefit of priority from the prior Japanese Patent Application No. 2022-185482 filed on Nov. 21, 2022, the entire contents of which are incorporated herein by reference.

### BACKGROUND

### Technical Field

The present disclosure relates to a power storage device, such as a battery or a capacitor, in which a terminal member is fixed via a resin member to a case member that constitutes a part of a case.

### Related Art

As a power storage device, there is known a rectangular battery in which positive and negative terminal members are each fixed to a case having a rectangular parallelepiped box-like shape via a resin member. Specifically, the case is composed of: a bottomed rectangular tube-shaped case body having a rectangular annular opening portion; and a rectangular plate-shaped lid which is joined to the case body over the entire circumference thereof to close the opening portion. In addition, the positive and negative terminal members are inserted individually in a pair of insertion holes provided in the lid, and extend from the inside to the outside of the case. A pair of resin members are joined to the lid and the terminal members, while insulating between the lid and the terminal members, to fix the terminal members to the lid. Examples of a related conventional art are disclosed in Japanese unexamined patent application publications No. 2010-272324 (JP2010-272324 A) and 2018-097978 (JP2018-097978 A) (see FIGS. 1 and 2 of JP2010-272324 A and FIGS. 1 to 3 of JP2018-097978 A).

### SUMMARY

### Technical Problems

In the above-described battery, it is desired to increase the electrical insulation between a terminal outer surface, which is exposed on the outer side of the lid (case member), of the terminal member and a case outer surface exposed on the outer side of the lid (case member). This is because the electrical insulation between the terminal outer surface and the case outer surface may decrease due to dust or moisture adhering to the battery. Meanwhile, due to various limitations in designing the battery, it may be difficult to increase the electrical insulation between the terminal outer surface and the case outer surface by increasing the overall size of the resin member.

The present disclosure has been made in view of such circumstances, and provides a power storage device that can increase the electrical insulation between a terminal outer surface of a terminal member and a case outer surface of a case member without increasing the overall size of a resin member.

### Means of Solving the Problems

(1) One aspect of the present disclosure to solve the above problem is to provide a power storage device comprising: a case member including an insertion hole; a terminal member inserted in the insertion hole of the case member; and a resin member joined to the case member and the terminal member while insulating between the case member and the terminal member, to fix the terminal member to the case member, wherein the resin member includes, on a resin outer surface exposed on an outer side of the case member, at least any one of a recess and a projection portion increasing a creepage distance from a terminal outer surface, exposed on the outer side of the case member, of the terminal member to a case outer surface exposed on the outer side of the case member.

In the above-described power storage device, the resin outer surface of the resin member includes at least the recess or the projection portion increasing the creepage distance from the terminal outer surface of the terminal member to the case outer surface of the case member. Accordingly, the electrical insulation between the terminal outer surface of the terminal member and the case outer surface of the case member can be increased without increasing the overall size of the resin member.

The above-described recess or projection portion is preferably provided on the resin outer surface annularly to surround the periphery of the terminal outer surface. This is because the creepage distance between the terminal outer surface and the case outer surface can be increased over the entire circumference, thereby increasing the electrical insulation between the terminal top surface and the case outer surface over the entire circumference.

(2) Further, in the power storage device described in the above (1), preferably, the terminal member includes a terminal outer portion located on the outer side of the case member, the terminal outer portion including a terminal top surface of a flat shape forming the terminal outer surface, the resin member includes a resin outer frame portion located on the outer side of the case member, having a frame shape that surrounds a periphery of the terminal outer portion of the terminal member, and including a frame top surface flush with the terminal top surface of the terminal outer portion, and the resin member includes, on the frame top surface of the resin outer surface, the recess of an annular shape surrounding a periphery of the terminal top surface.

In the above-described power storage device, the recess surrounding the periphery of the terminal top surface is provided on the frame top surface of the resin outer frame portion of the resin outer surface of the resin member. Therefore, a portion of the resin member does not protrude outside the terminal top surface as in the case where a projection portion is provided on the frame top surface, and the creepage distance between the terminal top surface and the case outer surface can be increased without interfering with connection of a busbar or the like to the terminal top surface. In addition, the creepage distance between the terminal top surface and the case outer surface can be increased over the entire circumference, thereby increasing the electrical insulation between the terminal top surface and the case outer surface over the entire circumference.

As the annular recess, a single recess may be provided on the frame top surface, or double or more recesses may be provided thereon.

### BRIEF DESCRIPTION OF THE DRAWINGS

FIG. 1 is a perspective view of a battery in a first embodiment;

FIG. 2 is a cross-sectional view of the battery in the first embodiment taken along a battery height direction and a battery width direction;

FIG. 3 is a partially enlarged top view of a terminal member and a resin member of the battery, and their surroundings in the first embodiment;

FIG. 4 is a cross-sectional view of the terminal member and the resin member of the battery, and their surroundings in the first embodiment, as seen in a direction indicated by arrows A-A in FIGS. 3 and 5;

FIG. 5 is a cross-sectional view of the terminal member and the resin member of the battery, and their surroundings in the first embodiment, as seen in a direction indicated by arrows B-B in FIGS. 3 and 4;

FIG. 6 is a partially enlarged top view of a terminal member and a resin member of a battery, and their surroundings in a second embodiment;

FIG. 7 is a cross-sectional view of the terminal member and the resin member of the battery, and their surroundings in the second embodiment, as seen in a direction indicated by arrows A-A in FIGS. 6 and 8; and

FIG. 8 is a cross-sectional view of the terminal member and the resin member of the battery, and their surroundings in the second embodiment, as seen in the direction of arrows B-B in FIGS. 6 and 7.

### DETAILED DESCRIPTION OF THE EXEMPLARY EMBODIMENTS

### First Embodiment

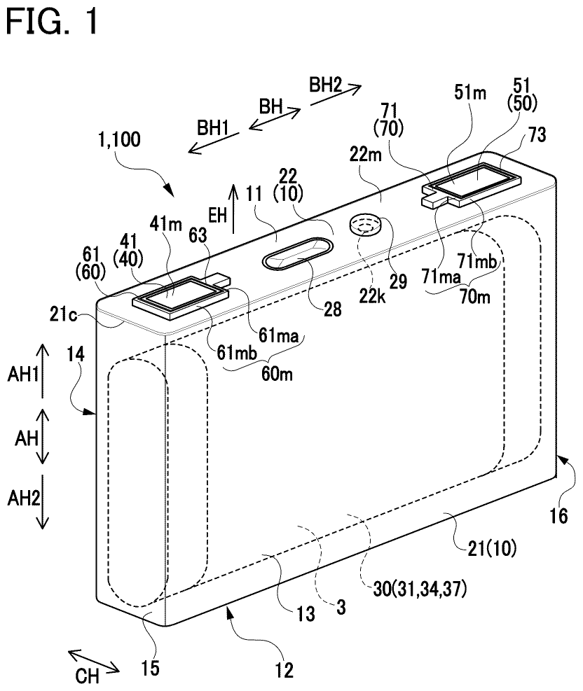

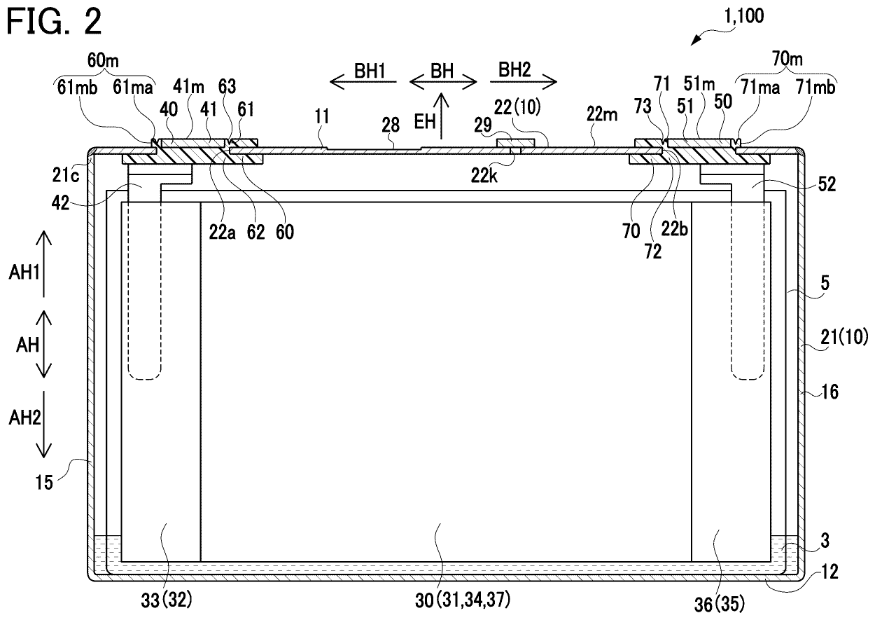

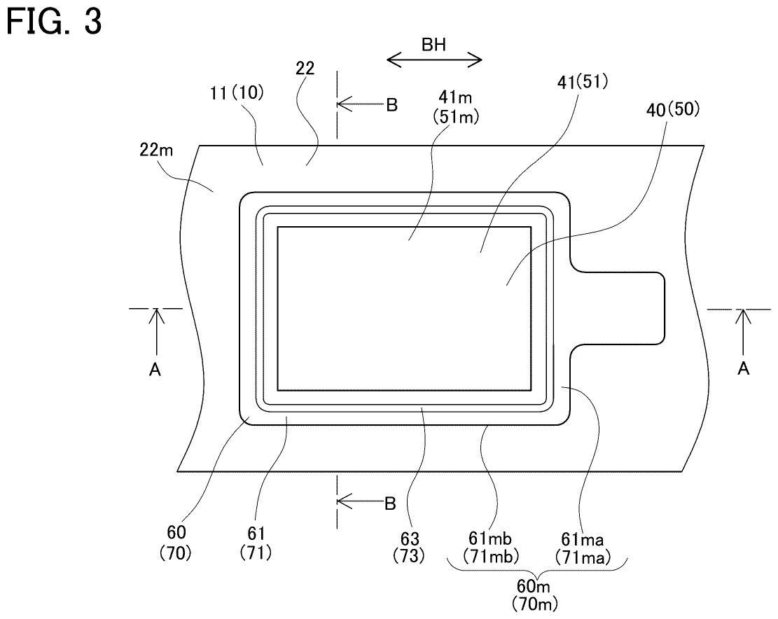

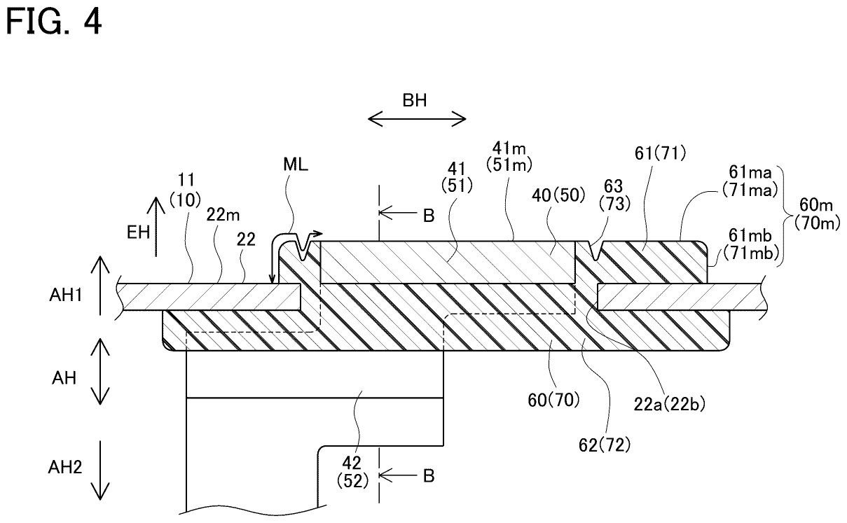

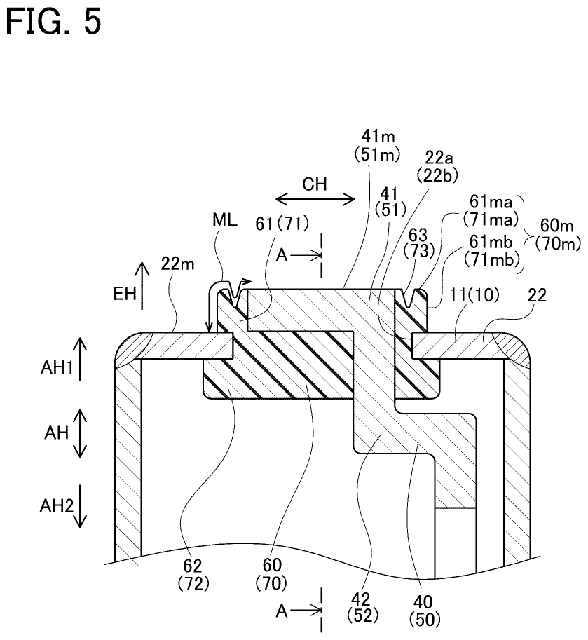

Hereinafter, a first embodiment of the present disclosure will be described with reference to the accompanying drawings. FIG. 1 shows a perspective view of a battery (one example of a power storage device of the present disclosure) 1 of the first embodiment, and FIG. 2 shows a cross-sectional view of the battery 1. FIG. 3 shows a partially enlarged top view of a terminal member 40 and a resin member 60, and their surroundings. FIGS. 4 and 5 are partially enlarged cross-sectional views of the terminal member 40 and the resin member 60, and their surroundings. It is to be noted that a terminal member 50 and a resin member 70 are respectively identical in configuration to the terminal member 40 and the resin member 60 and therefore the reference signs of the terminal member 50, the resin member 70, and their parts are noted together in parentheses. In the following, a description will be given with a battery height direction AH, a battery width direction BH, and a battery thickness direction CH of the battery 1 being defined as directions shown in FIGS. 1 to. 5. The battery 1 is a rectangular i.e., a rectangular parallelepiped-shape, sealed lithium-ion secondary battery which will be installed in a vehicle, such as a hybrid car, a plug-in hybrid car, and an electric car.

The battery 1 includes a case 10, a flat wound electrode body 30 housed in the case 10, a positive terminal member 40 and the negative terminal member 50 supported on a case upper portion 11 (i.e., a lid 22) of the case 10, and others. In the case 10, the electrode body 30 is covered with a bag-shaped insulating holder 5 formed of an insulating film, opening on an upper side AH1 in the battery height direction AH. In addition, the case 10 contains therein an electrolyte 3, a part of which is impregnated in the electrode body 30, and the remaining part of which is accumulated on a case bottom portion 12 of the case 10.

The case 10 is made of a metal (e.g., aluminum in the first embodiment), and has a rectangular parallelepiped box-like shape. This case 10 includes the rectangular case upper portion 11 located on the upper side AH1 in the battery height direction AH, the rectangular case bottom portion 12 opposing the case upper portion 11 and located on a lower side AH2 in the battery height direction AH, and four rectangular case side portions 13, 14, 15, and 16 connecting these portions 11 and 12. Specifically, the case 10 includes: a bottomed rectangular tube-shaped case body 21 including a rectangular annular opening portion 21c on the upper side AH1; and the rectangular plate-shaped lid (one example of a case member of the present disclosure) 22 laser-welded to the case body 21 over the entire circumference thereof to close the opening portion 21c.

The case upper portion 11 (i.e., the lid 22) is provided with a safety valve 28 which will break and open when the internal pressure of the case 10 exceeds a valve opening pressure. The lid 22 is also provided with a liquid inlet 22k which communicates between the inside and the outside of the case 10, and the liquid inlet 22k is hermetically sealed with a disc-shaped sealing member 29 made of aluminum.

Furthermore, the lid 22, rectangular insertion holes 22a and 22b are provided near end portions on one side BH1 and another side BH2, which is the other side opposite to the one side BH1, in the battery width direction BH, respectively. The positive terminal member 40 made of aluminum is inserted into the insertion hole 22a, and is fixed to the lid 22 via the resin member 60 in a state where the positive terminal member 40 is insulated from the case 10. In addition, the negative terminal member 50 made of copper is inserted into the other insertion hole 22b, and is fixed to the lid 22 via a resin member 70 in a state where the negative terminal member 50 is insulated from the case 10.

These terminal members 40 and 50 are each provided by punching a metal plate (concretely, an aluminum plate for the positive terminal member 40 and a copper plate for the negative terminal member 50) into a predetermined shape and bending the metal plate. The terminal members 40 and 50 respectively include terminal outer portions 41 and 51 located on an outer side EH of the lid 22, and terminal inner portions 42 and 52 mainly located inside the case 10 and respectively connected to the terminal outer portions 41 and 51 via the insertion holes 22a and 22b. The terminal outer portions 41 and 51 each have a rectangular flat shape, and include entirely exposed rectangular flat terminal top surfaces 41m and 51m, respectively. In the first embodiment, the terminal top surfaces 41m and 51m form terminal outer surfaces, which are exposed on the outer side EH of the lid 22, of the terminal members 40 and 50. The positive terminal inner portion 42 is joined and electrically conductive to a positive current collecting portion 33 of the electrode body 30, which will be described later, in the case 10. Meanwhile, the negative terminal inner portion 52 is joined and electrically conductive to a negative current collecting portion 36 of the electrode body 30, which will be described later, in the case 10.

Next, the resin members 60 and 70 will be described. The positive resin member 60 is joined to the lid 22 and the terminal member 40 while insulating between the lid 22 and the terminal member 40, to fix the terminal member 40 to the lid 22. In addition, the negative resin member 70 is joined to the lid 22 and the terminal member 50 while insulating between the lid 22 and the terminal member 50, to fix the terminal member 50 to the lid 22.

These resin members 60 and 70 are formed by performing insert-molding in a state where the terminal members 40 and 50 are inserted in the insertion holes 22a and 22b of the lid 22, respectively. The resin members 60 and 70 are made of polyphenylene sulfide (PPS), and include resin outer frame portions 61 and 71 which are located on the outer side EH of the lid 22, and resin inner portions 62 and 72 which are located inside the case 10 and in the insertion holes 22a and 22b of the lid 22 and which are connected to the resin outer frame portions 61 and 71, respectively. The resin outer frame portion 61 insulates between the terminal outer portion 41 of the terminal member 40 and the lid 22, while the resin outer frame portion 71 insulates between the terminal outer portion 51 of the terminal member 50 and the lid 22. Meanwhile, the resin inner portion 62 insulates between the terminal inner portion 42 of the terminal member 40 and the lid 22, while the resin inner portion 72 insulates between the terminal inner portion 52 of the terminal member 50 and the lid 22.

The resin outer frame portion 61 has a frame shape surrounding the periphery of the terminal outer portion 41 of the terminal member 40, and includes a frame top surface 61ma flush with the terminal top surface 41m of the terminal outer portion 41, and a frame side surface 61mb extending from the periphery of the frame top surface 61ma to the lower side AH2. Similarly, the resin outer frame portion 71 has a frame shape surrounding the terminal outer portion 51 of the terminal member 50, and includes a frame top surface 71ma flush with the terminal top surface 51m of the terminal outer portion 51, and a frame side surface 71mb extending from the periphery of the frame top surface 71ma to the lower side AH2. In the first embodiment, the frame top surfaces 61ma and 71ma and the frame side surfaces 61mb and 71mb correspond to resin outer surfaces 60m and 70m, which are exposed on the outer side EH of the lid 22, of the resin members 60 and 70.

Recesses 63 and 73 of V-shaped cross sections are formed on the resin outer surfaces 60m and 70m of the resin members 60 and 70, specifically, on the frame top surfaces 61ma and 71ma of the resin outer frame portions 61 and 71 of the resin outer surfaces 60m and 70m, in a rectangular annular shape to respectively surround the peripheries of the terminal top surfaces 41m and 51m. By providing such recesses 63 and 73, creepage distances ML from the terminal top surfaces 41m and 51m of the terminal members 40 and 50 to a lid outer surface (i.e., a case outer surface) 22m exposed on the outer side EH of the lid 22 are longer than those in the case where the recesses 63 and 73 are not provided.

Next, the electrode body 30 will be described. The electrode body 30 is produced in such a manner that a strip-shaped positive electrode plate 31 and a strip-shaped negative electrode plate 34 are stacked alternately with a pair of separators 37, each composed of a strip-shaped porous resin film interposed one between the electrode plates 31 and 34. and this stacked assembly is wound into a cylindrical shape, and then pressed into a flat shape. The electrode body 30 is housed in the case 10 oriented sideways with its axis coinciding with the battery width direction BH. An end portion of the electrode body 30 on the one side BH1 in the battery width direction BH is the positive current collecting portion 33 in which a positive current collecting foil 32 of the positive electrode plate 31 protrudes in a spiral form. The positive current collecting portion 33 is joined to the terminal inner portion 42 of the positive terminal member 40. Another end portion of the electrode body 30 on the other side BH2 in the battery width direction BH is the negative current collecting portion 36 in which a negative current collecting foil 35 of the negative electrode plate 34 protrudes in a spiral form. The negative current collecting portion 36 is joined to the terminal inner portion 52 of the negative terminal member 50.

As described above, in the battery 1, the resin outer surfaces 60m and 70m of the resin members 60 and 70 include the recesses 63 and 73 which increase the creepage distances ML from the terminal top surfaces (terminal outer surfaces) 41m and 51m of the terminal members 40 and 50 to the lid outer surface 22m of the lid 22. Accordingly, the electrical insulation between the terminal top surfaces 41m and 51m of the terminal members 40 and 50 and the lid outer surface 22m of the lid 22 can be increased without increasing the overall sizes of the resin members 60 and 70.

Furthermore, in the first embodiment, the annular recesses 63 and 73 surrounding the peripheries of the terminal top surfaces 41m and 51m are provided on the frame top surfaces 61ma and 71ma of the resin outer frame portions 61 and 71 of the resin outer surfaces 60m and 70m of the resin members 60 and 70. Therefore, portions of the resin members 60 and 70 do not protrude on the outer side EH from the terminal top surfaces 41m and 51m as in a battery 100 in a second embodiment described later in which projection portions 65 and 75 are provided on the frame top surfaces 61ma and 71ma. The creepage distances ML from the terminal top surfaces 41m and 51m to the lid outer surface 22m can be thus increased without interfering with connection of busbars (not shown) to the terminal top surfaces 41m and 51m. In addition, the creepage distances ML from the terminal top surfaces 41m and 51m to the lid outer surface 22m can be increased over the entire circumference, thereby increasing the electrical insulation between the terminal top surfaces 41m and 51m and the lid outer surface 22m over the entire circumference.

### Second Embodiment

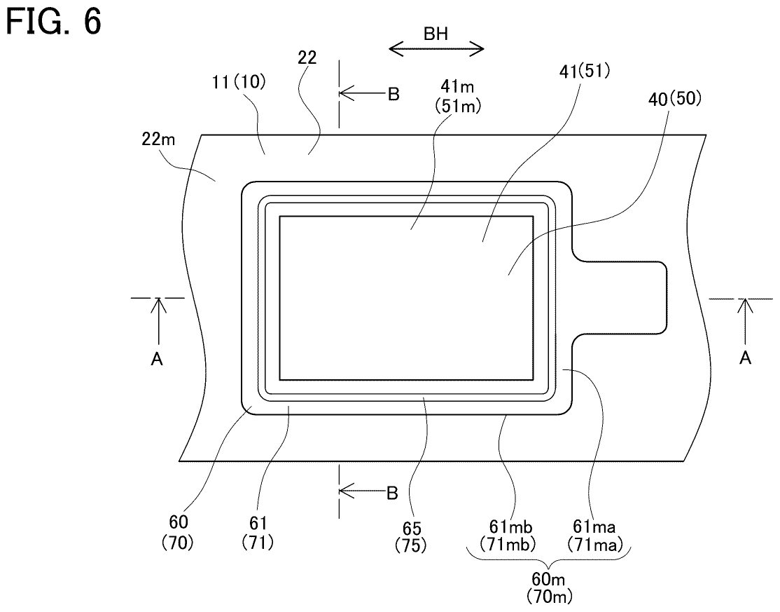

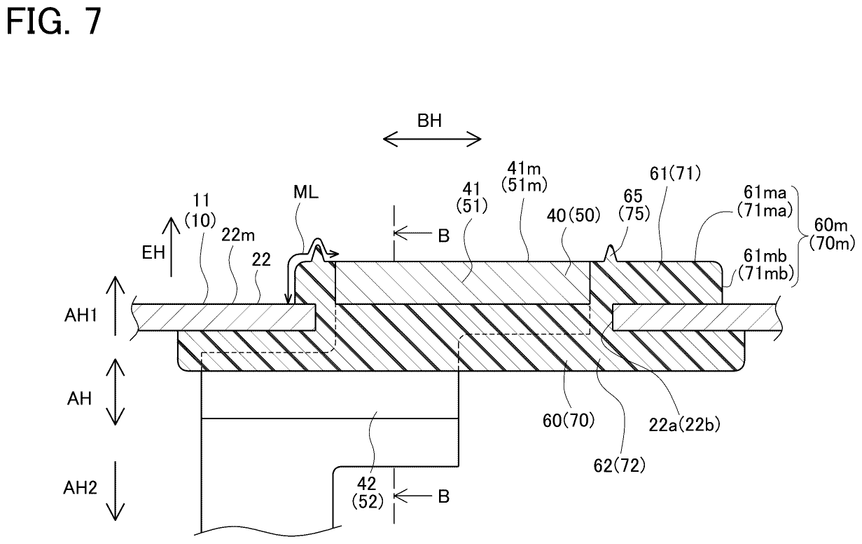

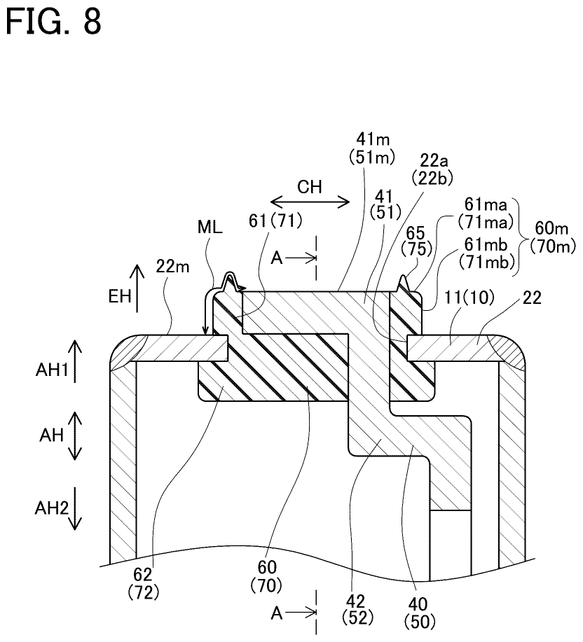

The second embodiment will be described next (see FIGS. 6 to 8). The description of the same parts as those in the first embodiment is omitted or simplified. In the battery 1 of the first embodiment, the recesses 63 and 73 which increase the creepage distances ML are provided on the frame top surfaces 61ma and 71ma of the resin outer surfaces 60m and 70m of the resin members 60 and 70. In contrast, in the battery 100 of the second embodiment, the projection portions 65 and 75 which increase the creepage distances ML are provided on the frame top surfaces 61ma and 71ma of the resin outer surfaces 60m and 70m of the resin members 60 and 70, which is different from the battery 1 of the first embodiment.

Specifically, the projection portions 65 and 75 are formed on the frame top surfaces 61ma and 71ma of the resin outer frame portions 61 and 71 of the resin outer surfaces 60m and 70m of the resin members 60 and 70 in a rectangular annular shape to respectively surround the peripheries of the terminal top surfaces 41m and 51m. Accordingly, the creepage distances ML from the terminal top surfaces 41m and 51m of the terminal members 40 and 50 to the lid outer surface 22m of the lid 22 are longer than those in the case where the projection portions 65 and 75 are not provided.

As described above, in the battery 100 of the second embodiment, the resin outer surfaces 60m and 70m include the projection portions 65 and 75 which increase the creepage distances ML from the terminal top surfaces 41m and 51m to the lid outer surface 22m, so that the electrical insulation between the terminal top surfaces 41m and 51m and the lid outer surface 22m can be increased without increasing the overall sizes of the resin members 60 and 70. In addition, the same parts as those in the first embodiment achieve the same effects as in the first embodiment.

While the present disclosure has been described above based on the first and second embodiments, it should be understood that the present disclosure is not limited to the first and second embodiments but can be applied with modifications appropriately made thereto without departing from the scope of the gist of the present disclosure.

### REFERENCE SIGNS LIST

1,100 Battery (power storage device)
10 Case
21 Case body
22 Lid (case member)
22m Lid outer surface (case outer surface)
22a,22b Insertion hole
30 Electrode body
40,50 Terminal member
41,51 Terminal outer portion
41m, 51m Terminal top surface (terminal outer surface)
60,70 Resin member
60m, 70m Resin outer surface
61, 71 Resin outer frame portion
61ma, 71ma Frame top surface
61mb,71mb Frame side surface
63,73 Recess
65,75 Projection portion
EH Outer side (of the lid)
ML Creepage distance

What is claimed is:

1. A power storage device comprising:
a case member including an insertion hole;
a terminal member inserted in the insertion hole of the case member; and
a resin member joined to the case member and the terminal member while insulating between the case member and the terminal member, to fix the terminal member to the case member, wherein
the resin member includes, on a resin outer surface exposed on an outer side of the case member, at least any one of a recess and a projection portion increasing a creepage distance from a terminal outer surface, exposed on the outer side of the case member, of the terminal member to a case outer surface exposed on the outer side of the case member.

2. The power storage device according to claim 1, wherein
the terminal member includes a terminal outer portion located on the outer side of the case member, the terminal outer portion including a terminal top surface of a flat shape forming the terminal outer surface,
the resin member includes a resin outer frame portion located on the outer side of the case member, having a frame shape that surrounds a periphery of the terminal outer portion of the terminal member, and including a frame top surface flush with the terminal top surface of the terminal outer portion, and
the resin member includes, on the frame top surface of the resin outer surface, the recess of an annular shape surrounding a periphery of the terminal top surface.
